(19) United States
(12) Patent Application Publication
(10) Pub. No.: US 2024/0406865 A1
(43) Pub. Date: Dec. 5, 2024

(54) METHODS AND APPARATUSES FOR POWER SAVING

(71) Applicant: LENOVO (BEIJING) LIMITED, Beijing (CN)

(72) Inventors: Yuantao ZHANG, Beijing (CN); Hongmei LIU, Beijing (CN); Zhi YAN, Beijing (CN); Yingying LI, Beijing (CN); Haiming WANG, Beijing (CN)

(21) Appl. No.: 18/694,763

(22) PCT Filed: Sep. 30, 2021
(86) PCT No.: PCT/CN2021/122426

§ 371 Date: Mar. 22, 2024

(51) Int. Cl. H04W 52/02; H04W 72/232

(52) U.S. Cl. CPC H04W 52/0229; H04W 72/232

(57) ABSTRACT

Embodiments of the present disclosure relate to methods and apparatuses for power saving. According to an embodiment of the present disclosure, a method can include: receiving configuration information including at least one candidate for physical downlink control channel (PDCCH) skipping, wherein each candidate indicates a number of PDCCH monitoring occasions or a time period; receiving downlink control information (DCI) indicating one candidate of the at least one candidate for a current active search space set (SSS) group (SSSG); and determining a number of skipped PDCCH monitoring occasions or a skipped time period for each SSS included in the current active SSSG based on the one candidate.

### TECHNICAL FIELD

Embodiments of the present application generally relate to wireless communication technologies, and especially to methods and apparatuses for power saving.

### BACKGROUND

In new radio (NR) system, a physical downlink control channel (PDCCH) carries downlink control information (DCI) which is used for downlink/uplink (DL/UL) data scheduling, slot format indication, etc.

For a user equipment (UE) in a radio resource control (RRC)_CONNECTED state, to reduce the power consumption, it is expected to reduce the unnecessary PDCCH monitoring as much as possible. As a result, PDCCH monitoring may be adapted to the traffic status more dynamically.

Given the above, the industry desires an improved technology for power saving when both the PDCCH skipping scheme and the search space set group (SSSG) switching scheme are supported in the NR.

### SUMMARY OF THE DISCLOSURE

Embodiments of the present application at least provide a technical solution for power saving, which provides methods on quite a few areas for PDCCH based power saving adaptation.

According to some embodiments of the present application, a method performed by a UE may include: receiving configuration information including at least one candidate for PDCCH skipping, wherein each candidate indicates a number of PDCCH monitoring occasions or a time period; receiving DCI indicating one candidate of the at least one candidate for a current active SSSG; and determining a number of skipped PDCCH monitoring occasions or a skipped time period for each search space set (SSS) included in the current active SSSG based on the one candidate.

According to some embodiments of the present application, a method performed by a base station (BS) may include: transmitting configuration information including at least one candidate for PDCCH skipping, wherein each candidate indicates a number of PDCCH monitoring occasions or a time period; determining a number of skipped PDCCH monitoring occasions or a skipped time period for each SSS included in a current SSSG based on one candidate of the at least one candidate; transmitting DCI indicating the one candidate of the at least one candidate.

Some embodiments of the present application provide a UE including: a processor; and a transceiver coupled to the processor, wherein the transceiver is configured to: receive configuration information including at least one candidate for PDCCH skipping, wherein each candidate indicates a number of PDCCH monitoring occasions or a time period; and receive DCI indicating one candidate of the at least one candidate for a current active SSSG; wherein the processor is configured to: determine a number of skipped PDCCH monitoring occasions or a skipped time period for each SSS included in the current active SSSG based on the one candidate.

Some other embodiments of the present application provide a BS including: a processor; and a transceiver coupled to the processor, wherein the transceiver is configured to: transmit configuration information including at least one candidate for PDCCH skipping, wherein each candidate indicates a number of PDCCH monitoring occasions or a time period; and transmit DCI indicating one candidate of the at least one candidate for a current active SSSG; wherein the processor is configured to: determine a number of skipped PDCCH monitoring occasions or a skipped time period for each SSS included in the current active SSSG based on the one candidate.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates exemplary SSS configurations according to some embodiments of the present application;

FIG. 3 illustrates an exemplary PDCCH skipping scheme according to some embodiments of the present application;

FIG. 4 illustrates an exemplary SSSG switching scheme according to some embodiments of the present application;

FIG. 5 illustrates an exemplary state diagram of PDCCH skipping and SSSG switching according to some embodiments of the present application;

FIG. 6 illustrates an exemplary timer-based SSSG switching according to some embodiments of the present application;

FIG. 7 is a flow chart illustrating an exemplary method for power saving according to some embodiments of the present application;

FIG. 8 illustrates an exemplary method for determining the skipped PDCCH monitoring occasions for each SSS in a SSSG according to some embodiments of the present application;

FIG. 9 illustrates another exemplary method for determining the skipped PDCCH monitoring occasions for each SSS in a SSSG according to some embodiments of the present application;

FIG. 10 illustrates an exemplary operation in a scenario where PDCCH skipping is indicated when a SSSG switching timer is running according to some embodiments of the present application;

FIG. 11 illustrates another exemplary operation in a scenario where PDCCH skipping is indicated when a SSSG switching timer is running according to some other embodiments of the present application;

FIG. 12 is a flow chart illustrating an exemplary method for power saving according to some other embodiments of the present application; and

FIG. 13 illustrates a simplified block diagram of an exemplary apparatus for power saving according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G (i.e., new radio (NR)), 3GPP long term evolution (LTE) Release 8 and so on. Persons skilled in the art know very well that, with the development of network architecture and new service scenarios, the embodiments in the present application are also applicable to similar technical problems; and moreover, the terminologies recited in the present application may change, which should not affect the principle of the present application.

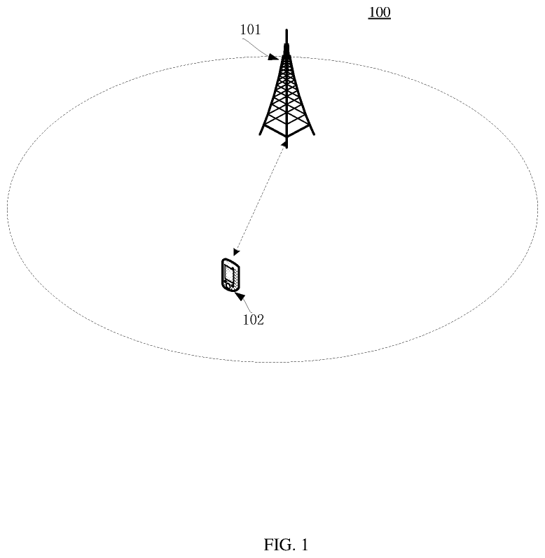

FIG. 1 is a schematic diagram illustrating an exemplary wireless communication system 100 according to an embodiment of the present application.

As shown in FIG. 1, the wireless communication system 100 includes at least one BS 101 and at least one UE 102. In particular, the wireless communication system 100 includes one BS 101 and one UE 102 for illustrative purpose. Although a specific number of BS 101 and UE 102 are depicted in FIG. 1, it is contemplated that any number of BSs and UEs may be included in the wireless communication system 100.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

In some embodiments, the UE 102 may include a computing device, such as a desktop computer, a laptop computer, a personal digital assistant (PDA), a tablet computer, a smart television (e.g., a television connected to the Internet), a set-top box, a game console, a security system (including security cameras), a vehicle on-board computer, a network device (e.g., a router, a switch, and a modem), or the like. In some embodiments, the UE 102 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 102 may include a wearable device, such as a smart watch, a fitness band, an optical head-mounted display, or the like. Moreover, the UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In NR system, PDCCH carries DCI which is used for DL/UL data scheduling, slot format indication, etc. PDCCH is monitored by a UE in the configured search space sets. There are two types of search space sets, i.e., common search space sets (CSSs) and UE specific search space sets (USSs). The CSS is mostly shared by one or more UEs and could be configured either in system information block (SIB) or a UE specific signaling (e.g., an RRC signaling), while the USS is configured per UE.

A search space set is configured to be associated with a control resource set (CORESET), which defines the time (i.e., the number of OFDM symbols) and frequency resources for PDCCH monitoring. The parameters for an SSS may be configured in SearchSpace information element (IE) as specified in 3GPP standard documents. For example, Table 1 shows some relevant configuration fields and the associated descriptions included in an SSS configuration.

TABLE 1
Relevant fields in an SSS configuration

| Configuration fields | Descriptions |
|---|---|
| searchSpaceId | Search space set ID |
| controlResourceSetId | Associated CORESET ID |
| monitoringSlotPeriod- | Slots for PDCCH Monitoring |
| icityAndOffset | configured as periodicity and offset |
| duration | Number of consecutive slots in |
| | each PDCCH monitoring periodicity |
| monitoringSymbolsWithinSlot | Starting OFDM symbols for PDCCH |
| | monitoring in the slots configured for |
| | PDCCH monitoring |
| nrofCandidates | Number of candidates |
| | per aggregation level (0, 1, 2, |
| | 3, 4, 5, 6, 8) |
| searchSpaceType | Indicates whether this is a |
| | common search space or a UE |
| | specific search space |

Referring to Table 1, the value of the parameter searchSpaceId may be an identifier (ID) of the SSS. The value of the parameter controlResourceSetId may be an ID of the CORESET associated with the SSS. The value of the parameter monitoringSlotPeriodicityAndOffset may indicate a PDCCH monitoring periodicity and offset, which is in terms of slots (also referred to as time slots). The value of the parameter duration may indicate a number of consecutive slots in each PDCCH monitoring periodicity. The value of the parameter monitoringSymbolsWithinSlot may indicate starting OFDM symbols for PDCCH monitoring in the slots configured for PDCCH monitoring. The value of the parameter nrofCandidates may indicate aggregation levels in the search space set and the number of candidates for each aggregation level. The number of candidates for each aggregation level may be 0, 1, 2, 3, 4, 5, 6, or 8. The value of the parameter searchSpaceType may indicate whether the SSS is a CSS or a USS.

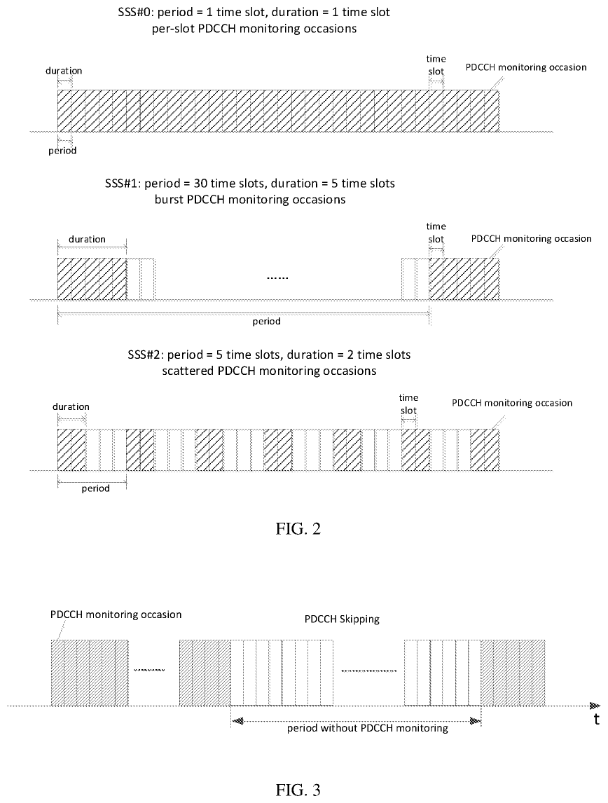

PDCCH monitoring occasions may be determined based on the above SSS configuration. For example, FIG. 2 illustrates exemplary SSS configurations according to some embodiments of the present application, based on which the UE may determine PDCCH monitoring occasions.

Referring to FIG. 2, it shows three SSS configurations, e.g., SSS #0, SSS #1, and SSS #2. Based on each configuration, the UE may determine corresponding PDCCH monitoring occasions.

For example, in SSS #0, the periodicity for PDCCH monitoring is 1 slot and the duration for PDCCH monitoring is 1 slot, then the UE may need to monitor a PDCCH monitoring occasion in each time slot. Such kind of PDCCH monitoring occasions may be referred to as per-slot PDCCH monitoring occasions.

In SSS #1, the periodicity for PDCCH monitoring is 30 slots and the duration for PDCCH monitoring is 5 slots, then the UE may need to monitor 5 PDCCH monitoring occasions every 30 time slots. Such kind of PDCCH monitoring occasions may be referred to as burst PDCCH monitoring occasions.

In SSS #2, the periodicity for PDCCH monitoring is 5 slots and the duration for PDCCH monitoring is 2 slots, then the UE may need to monitor 2 PDCCH monitoring occasions every 5 time slots. Such kind of PDCCH monitoring occasions may be referred to as scattered PDCCH monitoring occasions.

For an RRC_CONNECTED UE in NR, to reduce the power consumption at the UE side, it is expected to reduce unnecessary PDCCH monitoring during the DRX active time while keeping data scheduling with low latency. As a result, the PDCCH monitoring may be adapted to the traffic status more dynamically. For example, the UE may spend more effort on PDCCH monitoring when data arrives. Before or after that, the UE may spend less effort on PDCCH monitoring for power saving.

Two candidate schemes for power saving may be used to reduce the unnecessary PDCCH monitoring. One is a PDCCH skipping scheme and the other is an SSSG switching scheme.

In the PDCCH skipping scheme, PDCCH monitoring can be dynamically skipped for a duration indicated by the BS. FIG. 3 illustrates an exemplary PDCCH skipping scheme according to some embodiments of the present application. Referring to FIG. 3, PDCCH is monitored in the configured PDCCH monitoring occasions when there are data packets waiting for the scheduling. After the data transmission, PDCCH monitoring is skipped for a period (i.e., a period without PDCCH monitoring for user data transmission).

In the SSSG switching scheme, one SSSG with high PDCCH monitoring effort (e.g., with low PDCCH monitoring periodicity or including dense PDCCH monitoring occasions) may be activated when there are high data volumes, while the UE may switch to another SSSG with low PDCCH monitoring effort (e.g., with high PDCCH monitoring periodicity or including sparser PDCCH monitoring occasions) when there is no data volume or low data volume for power saving.

Depending on the BS's configuration, an SSSG may include one or more SSSs, and one SSS may be included in (or associated with) one or more SSSGs. When an SSSG is activated, the UE may monitor PDCCH in the configured one or more SSS(s) in the SSSG.

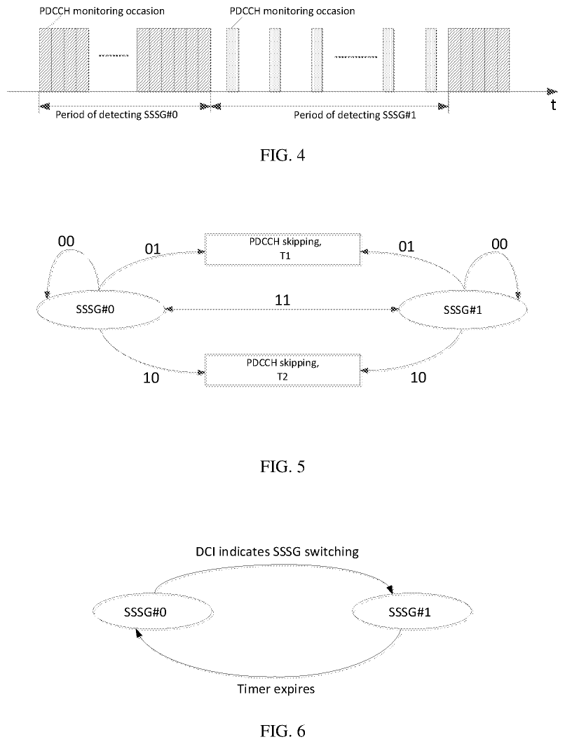

FIG. 4 illustrates an exemplary SSSG switching scheme according to some embodiments of the present application. Referring to FIG. 4, assuming that SSSG #0 with low PDCCH monitoring periodicity (or with denser PDCCH monitoring occasions) and SSSG #1 with high PDCCH monitoring periodicity (or with sparser PDCCH monitoring occasions) are configured, the UE may first monitor PDCCH in SSSG #0 and then switch to SSSG #1 for power saving. That is, in the example as shown in FIG. 4, SSSG #0 is activated in the period of detecting SSSG #0, and SSSG #1 is activated in the period of detecting SSSG #1.

Since the two schemes, i.e., the PDCCH skipping scheme and the SSSG switching scheme, may both be used for PDCCH monitoring, it is beneficial to strive for a common design for PDCCH monitoring adaptation, so as to support functionalities inclusive of both the PDCCH skipping scheme and the SSSG switching scheme. In addition, an indication indicating PDCCH skipping for a duration is also supported when two or more SSSGs are configured. In this case, PDCCH skipping is applied for the active SSSG.

Therefore, a state diagram on how to indicate both PDCCH skipping and SSSG switching may be defined. FIG. 5 illustrates an exemplary state diagram of PDCCH skipping and SSSG switching according to some embodiments of the present application.

Referring to FIG. 5, it is assumed that: two SSSGs (e.g., SSSG #0 and SSSG #1) are configured to the UE for SSSG switching; and for each SSSG, two time periods (e.g., T1 and T2) are configured to the UE for PDCCH skipping. The two time periods for different SSSGs may be configured with different values or the same values.

In order to indicate both the PDCCH skipping and the SSSG switching, the scheduling DCI transmitted from a BS may include a bit field. The bit field may have 2 bits corresponding to 4 codepoints, i.e., “00,” “01,” “10,” and “11.”

In the embodiment of FIG. 5, codepoint “00” indicates not performing an SSSG switching. That is, in the case that the current active SSSG of the UE is SSSG #0, the UE may stay at SSSG #0 and not switch to SSSG #1; in the case that the current active SSSG of the UE is SSSG #1, the UE may stay at SSSG #1 and not switch to SSSG #1.

Codepoint “01” indicates a PDCCH skipping for T1. That is, in the case that the current active SSSG of the UE is SSSG #0, the UE may perform PDCCH skipping for T1 (i.e., skipping the PDCCH monitoring occasions in T1); in the case that the current active SSSG of the UE is SSSG #1, the UE may perform PDCCH skipping for T1 (i.e., skipping the PDCCH monitoring occasions in T1). The values of T1 for SSSG #0 and SSSG #1 may be the same or different.

Codepoint “10” indicates a PDCCH skipping for T2. That is, in the case that the current active SSSG of the UE is SSSG #0, the UE may perform PDCCH skipping for T2 (i.e., skipping the PDCCH monitoring occasions in T2); in the case that the current active SSSG of the UE is SSSG #1, the UE may perform PDCCH skipping for T2 (i.e., skipping the PDCCH monitoring occasions in T2). The values of T2 for SSSG #0 and SSSG #1 may be the same or different.

Codepoint “11” indicates performing an SSSG switching. That is, in the case that the current active SSSG of the UE is SSSG #0, the UE may switch to SSSG #1, and vice versa.

In addition, a timer-based SSSG switching method may also be used for the UE for SSSG switching. In the timer-based SSSG switching method, the BS may configure an SSSG switching timer to the UE. The UE may start the timer when an SSSG switching happens, and switch back to the SSSG before the timer starts after the timer expires.

FIG. 6 illustrates an exemplary timer-based SSSG switching according to some embodiments of the present application.

Referring to FIG. 6, it is assumed that: two SSSGs (e.g., SSSG #0 and SSSG #1) are configured to the UE for SSSG switching and an SSSG switching timer is configured to the UE. At the beginning, the active SSSG for the UE is SSSG #0, in response to receiving DCI indicating an SSSG switching from SSSG #0 to SSSG #1, the UE may switch to SSSG #1 and start the SSSG switching timer. When the timer expires, the UE switches from SSSG #1 back to SSSG #0 for PDCCH monitoring.

In view of the above, there are still some issues need to be solved for PDCCH based power saving adaptation when both the PDCCH skipping scheme and the SSSG switching switching scheme are supported for the UE. For example, how PDCCH skipping is configured and determined for each SSSG, how PDCCH skipping applies for each SSS in a SSSG, how PDCCH skipping and SSSG switching operate when an SSSG switching timer is running and when timer is not running, and etc.

Given the above, embodiments of the present application may provide technical solutions for power saving, which proposes methods on quite a few areas for PDCCH based power saving adaptation, at least including how PDCCH skipping is configured and determined for each SSSG, how PDCCH skipping applies for each SSS of a SSSG, how PDCCH skipping and SSSG switching operate when an SSSG switching timer is running and when timer is not running, and so on. More details on embodiments of the present application will be described in the following text in combination with the appended drawings.

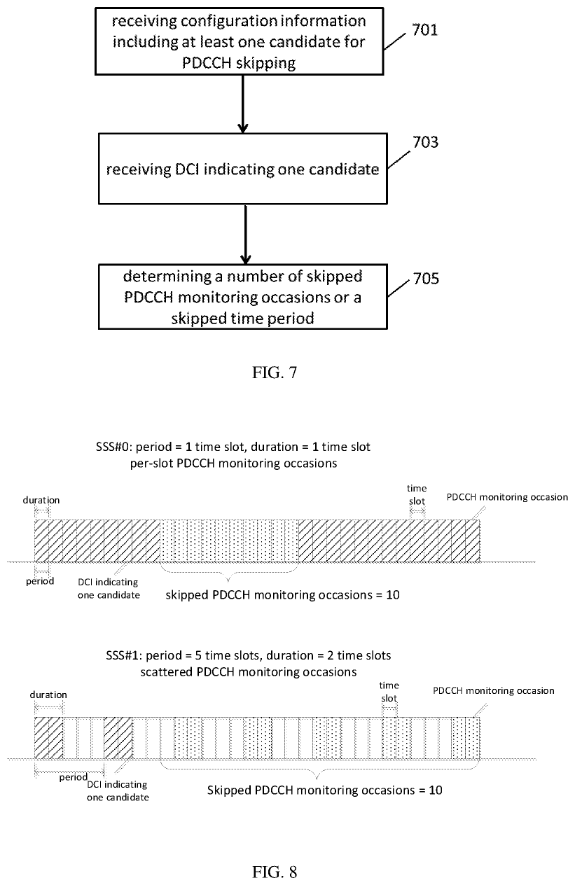

FIG. 7 is a flow chart illustrating an exemplary procedure of a method for power saving according to some embodiments of the present application. The method may be performed by a UE, for example, the UE 102 as shown in FIG. 1.

In the exemplary method shown in FIG. 7, in step 701, the UE may receive configuration information from a BS (e.g., the BS 101 as shown in FIG. 1). In some embodiments, the configuration information may include at least one candidate for PDCCH skipping. Each candidate indicates a number of PDCCH monitoring occasions or a time period.

In step 703, the UE may receive DCI from the BS. The DCI may indicate one candidate of the at least one candidate. For example, the DCI may include a bit field to indicate the one candidate.

In step 705, the UE may determine a number of skipped PDCCH monitoring occasions or a skipped time period for each SSS based on the one candidate. In an embodiment of the present application, each SSS is included in the current active SSSG. In another embodiment of the present application, the UE is not configured with any SSSG. In other words, all SSSs of the UE are not included in any SSSG. In such embodiments, the UE may determine a number of skipped PDCCH monitoring occasions or a skipped time period for each SSS of all the SSSs of the UE.

After determining the number of skipped PDCCH monitoring occasions or the skipped time period, the UE may perform PDCCH skipping in the number of skipped PDCCH monitoring occasions or the skipped time period. In some embodiments of the present application, performing PDCCH skipping means not monitoring all the USSs and a portion of CSSs (e.g., the CSSs which schedule UL/DL data of the UE) in the number of skipped PDCCH monitoring occasions or the skipped time period, and the UE may still monitor the other portion of CSSs (e.g., the CSSs which transmit system information, paging and random access information, and so on) in the number of skipped PDCCH monitoring occasions or the skipped time period.

In some embodiments of the present application, the at least one candidate may be configured for all the SSSGs of the UE. All the SSSGs may refer to all of the SSSGs configured to the UE by the BS. In such embodiments, each candidate may include a number of PDCCH monitoring occasions.

Then, after receiving DCI indicating the one candidate, the UE may determine that the number of PDCCH monitoring occasions indicated by the one candidate is used for the current active SSSG of the UE. In such embodiments, even SSSG switching happens and active SSSG changes, when the same number of PDCCH monitoring occasions are indicated for the current active SSSG, the actual skipped time duration is different for a former active SSSG and the current active SSSG because the SSS configuration (e.g., periodicity, duration, and etc.) in each SSSG is different.

In some other embodiments of the present application, the at least one candidate may be configured for all the SSSs of the UE. In such embodiments, each candidate may include a number of PDCCH monitoring occasions.

Then, the UE may determine a number of skipped PDCCH monitoring occasions for each SSS in the current active SSSG or for each SSS of all the SSSs based on the number of PDCCH monitoring occasions indicated by the one candidate.

In an embodiment of the present application, the number of PDCCH monitoring occasions indicated in the one candidate may be applied for each SSS. In an embodiment of the present application, each SSS is included in the current active SSSG. In another embodiment of the present application, each SSS is not included in any SSSG. Then, for each SSS, the UE may determine the number of skipped PDCCH monitoring occasions to be the number of PDCCH monitoring occasions indicated in the one candidate. After determining the number of skipped PDCCH monitoring occasions, the UE may skip the number of skipped PDCCH monitoring occasions when performing PDCCH monitoring. This embodiment means that once the UE receives the DCI indicating to skip monitoring PDCCH in a certain number of PDCCH monitoring occasions, the UE will skip same number of PDCCH monitoring occasions for each SSS. Since each SSS may be configured with different PDCCH monitoring periodicity and/or monitoring durations, the absolute skipped time duration (e.g., in terms of time slots) of each SSS may be different.

FIG. 8 illustrates an exemplary method for determining the skipped PDCCH monitoring occasions for each SSS in a SSSG according to some embodiments of the present application.

Referring to FIG. 8, it is assumed that:
The current active SSSG is SSSG #0 including SSS #0 and SSS #1;
In SSS #0, the periodicity for PDCCH monitoring is 1 slot and the duration for PDCCH monitoring is 1 slot.
In SSS #1, the periodicity for PDCCH monitoring is 5 slots and the duration for PDCCH monitoring is 2 slots.
The DCI indicating the one candidate is received in slot k and the number of PDCCH monitoring occasions indicated by the one candidate is 10 PDCCH monitoring occasions.
The 10 PDCCH monitoring occasions are used for each SSS in SSSG #0.

Then, after receiving the DCI, for SSS #0 and SSS #1, the UE may both skip 10 PDCCH monitoring occasions from slot k+2. However, the actual skipped time period for SSS #0 and SSS #1 are totally different because the configurations for SSS #0 and SSS #1 are different. Although in this embodiment, the time duration between a time receiving DCI and a time starting the PDCCH skipping is 2 slots, the time duration may be other values (e.g., one or more time slots, or one or more orthogonal frequency division multiplexing (OFDM) symbols) in some other embodiments of the present application.

In another embodiment of the present application, the number of PDCCH monitoring occasions indicated in the one candidate may be applied for a reference SSS. In an embodiment of the present application, the reference SSS is included in the current active SSSG. In another embodiment of the present application, the reference is included in all the SSSs of the UE. Then, for the reference SSS included, the UE may determine the number of skipped PDCCH monitoring occasions to be the number of PDCCH monitoring occasions indicated in the one candidate.

Then, the UE may determine a reference skipped time period (e.g., in terms of time slots) based on the number of PDCCH monitoring occasions indicated in the one candidate. For each SSS other than the reference SSS included in the current active SSSG or included in all the SSSs (in the case that no SSSG is configured for the UE), the UE may determine the number of skipped PDCCH monitoring occasions to be PDCCH monitoring occasions in the reference skipped time period.

In some embodiments of the present application, the reference SSS may be configured by a network. In some other embodiments of the present application, the reference SSS may be determined implicitly, for example, the reference SSS may be a USS with a lowest periodicity (in other words, most densest USS) in the current active SSSG or in all the SSSs (in the case that no SSSG is configured for the UE). In another example, the reference SSS may be a USS with lowest or highest index in the current active SSSG or in all the SSSs (in the case that no SSSG is configured for the UE). In yet another example, a default SSS might be defined in the current active SSSG or in all the SSSs (in the case that no SSSG is configured for the UE), and the reference SSS is the default SSS.

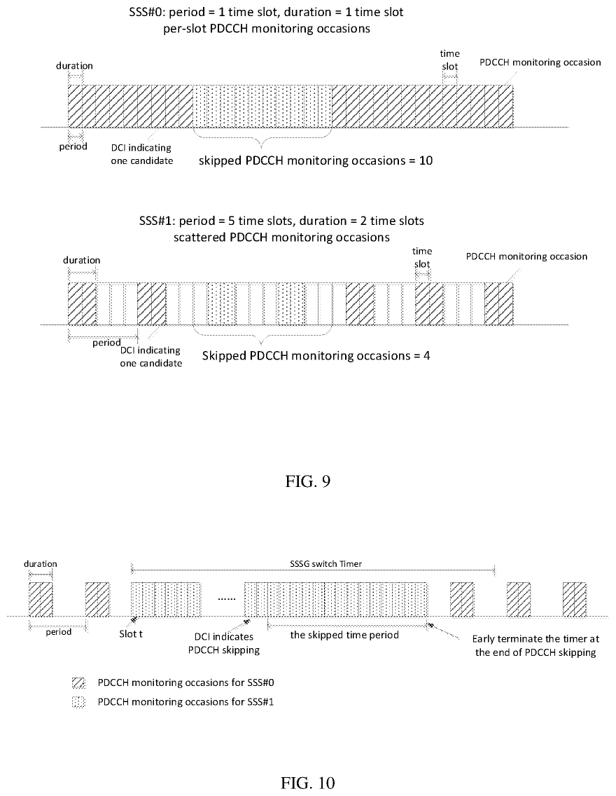

FIG. 9 illustrates another exemplary method for determining the skipped PDCCH monitoring occasions for each SSS in a SSSG according to some other embodiments of the present application.

Referring to FIG. 9, it is assumed that:
The current active SSSG is SSSG #0 including SSS #0 and SSS #1.
In SSS #0, the periodicity for PDCCH monitoring is 1 slot and the duration for PDCCH monitoring is 1 slot.
In SSS #1, the periodicity for PDCCH monitoring is 5 slots and the duration for PDCCH monitoring is 2 slots.
The DCI indicating the one candidate is received in slot k and the number of PDCCH monitoring occasions indicated by the one candidate is 10 PDCCH monitoring occasions.
The 10 PDCCH monitoring occasions are used for the reference SSS in the SSSG #0.

Referring to FIG. 9, the reference SSS may be SSS #0 with lowest periodicity. Then, after receiving the DCI, for SSS #0, the UE may skip 10 PDCCH monitoring occasions from slot k+2. Then, the UE may determine a reference time period based on the 10 PDCCH monitoring occasions, for example, the reference time period may be the time period including the 10 PDCCH monitoring occasions, i.e., 10 slots. Then, for the SSS #1, the UE may determine the PDCCH monitoring occasions included in the 10 slots from slot k+2 are the skipped PDCCH monitoring occasions, which includes 4 PDCCH monitoring occasions. Although in this embodiment, the time duration between a time receiving DCI and a time starting the PDCCH skipping is 2 slots, the time duration may be other values (e.g., one or more time slots, or one or more OFDM symbols) in some other embodiments of the present application.

In some other embodiments of the present application, the at least one candidate may be configured for a reference SSSG of all the SSSGs configured by the BS. In such embodiments, each candidate may include a time period.

In some embodiments of the present application, the reference SSSG may be configured by the network (e.g., BS). In some other embodiments of the present application, the reference SSSG may be determined implicitly, for example, the reference SSSG may be a densest SSSG in all the SSSGs. In another example, the reference SSSG may be a SSSG with lowest or highest index in all the SSSGs. In yet another example, a default SSSG might be defined in all the SSSGs, and the reference SSSG is the default SSSG.

Then, after receiving DCI indicating the one candidate, the UE may determine how the time period indicated by the one candidate is used for the current active SSSG.

In the case that the current SSSG is the reference SSSG, the UE may determine the time period can be directly used as the skipped time period for the current SSSG. Then, the UE may determine the skipped time period for each SSS included in the current active SSSG to be the time period indicated in the one candidate.

In the case that the current SSSG is not the reference SSSG, the UE may determine the time period cannot be directly used as the skipped time period for the current SSSG, and the skipped time period for the current SSSG may be determined based on the time period indicated in the one candidate and a scaling factor. That is, the UE may determine the skipped time period for each SSS included in the current active SSSG based on the time period indicated in the one candidate and a scaling factor. For example, the skipped time period may be determined to be the time period indicated in the one candidate multiplying the scaling factor.

In some embodiments of the present application, the scaling factor may be configured by the network (e.g., BS). In some other embodiments of the present application, the scaling factor may be determined based on a first number of PDCCH monitoring occasions (e.g., N1) within a determined time period of a first reference SSS of the reference SSSG and a second number of PDCCH monitoring occasions (N2) within the determined time period of a second reference SSS in the current active SSSG, for example, the scaling factor may be determined to be N1/N2.

In some embodiments, the determined time period may be configured by the network (e.g., BS). In some other embodiments of the present application, the time period may be the time period of reference SSS (e.g., the first reference SSS) of a SSSG.

The first reference SSS may be configured by a network or may be determined implicitly, for example, the first reference SSS may be a USS with a lowest periodicity (in other words, densest USS) in the reference SSSG. In another example, the first reference SSS may be a USS with lowest or highest index in the reference SSSG. In yet another example, a default SSS might be defined in the reference SSSG, and the first reference SSS is the default SSS.

Similarly, the second reference SSS may be configured by a network or may be determined implicitly, for example, the second reference SSS may be a USS with a lowest periodicity (in other words, densest USS) in the current active SSSG. In another example, the second reference SSS may be a USS with lowest or highest index in the current active SSSG. In yet another example, a default SSS might be defined in the current active SSSG, and the second reference SSS is the default SSS.

According to some embodiments of the present application, the current active SSSG may be a denser SSSG. When a PDCCH skipping is indicated, the SSSG can be changed to a sparser SSSG after ends of the PDCCH skipping.

In such embodiments, the PDCCH skipping may be indicated by DCI transmitted by the BS. The DCI may indicate a number of PDCCH monitoring occasions or a time period. For example, the DCI may be the DCI in the embodiments of FIG. 7, the DCI in the embodiments in FIG. 4, or any other DCI. Then, after receiving the DCI, the UE may determine a number of skipped PDCCH monitoring occasions or the skipped time period for the current SSSG.

After performing the PDCCH skipping for the current active SSSG (e.g., performing the PDCCH skipping for each SSS in the current active SSSG), the UE may determine whether to switch to an SSSG sparser than the current active SSSG in response to whether the number of skipped PDCCH monitoring occasions or the skipped time period is larger than or equal to a threshold. For example, in the case that the number of skipped PDCCH monitoring occasions or the skipped time period is larger than or equal to a threshold, the UE may determine to switch to an SSSG sparser than the current active SSSG.

In some embodiments of the present application, the threshold may be configured by the network (e.g., BS). In some other embodiments of the present application, the threshold may be determined based on (e.g., equal to) a PDCCH monitoring periodicity configured for a reference SSS of the SSSG sparser than the current active SSSG. In such embodiments, the reference SSS may be configured by a network or may be determined implicitly, for example, the reference SSS may be a USS with a lowest periodicity (in other words, densest USS) in the SSSG. In another example, the reference SSS may be a USS with a lowest index or a highest index in the SSSG. In yet another example, a default SSS might be defined in the SSSG, and the reference SSS is the default SSS.

For example, it is assumed that the BS configures two SSSGs to the UE, e.g., SSSG #0 and SSSG #1. SSSG #0 is the current active SSSG and is denser than SSSG #1. In order to determine whether to switch from SSSG #0 to SSSG #1 after ends of the PDCCH skipping for SSSG #0, one threshold may be used. In the case that the number of skipped PDCCH monitoring occasions or the skipped time period for SSSG #0 is larger than or equal to the one threshold, the UE may determine to switch from SSSG #0 to SSSG #1. The threshold may be configured by the BS or is equal to PDCCH monitoring periodicity for the reference SSS in SSSG #1.

In another example, it is assumed that the BS configures three SSSGs to the UE, e.g., SSSG #0, SSSG #1, and SSSG #2. SSSG #0 is the current active SSSG and is denser than SSSG #1 and SSSG #2, SSSG #1 is denser than SSSG #2. In order to determine whether to switch from SSSG #0 to SSSG #1 or SSSG #1 after ends of the PDCCH skipping for SSSG #0, two thresholds (e.g., threshold #1 and threshold #2) may be used. Threshold #2 is larger than threshold #1.

In the case that the number of skipped PDCCH monitoring occasions or the skipped time period for SSSG #0 is larger than or equal to threshold #2, the UE may determine to switch from SSSG #0 to SSSG #2. The threshold may be configured by the BS or is equal to PDCCH monitoring periodicity for the reference SSS in SSSG #2.

In the case that the number of skipped PDCCH monitoring occasions or the skipped time period for SSSG #0 is larger than or equal to threshold #1 but is less than threshold #2, the UE may determine to switch from SSSG #0 to SSSG #1. The threshold may be configured by the BS or is equal to PDCCH monitoring periodicity for the reference SSS in SSSG #1.

In the case that the number of skipped PDCCH monitoring occasions or the skipped time period for SSSG #0 is less than threshold #1, the UE may stay at SSSG #0 and not switch from SSSG #0 to SSSG #1 or SSSG #2.

According to some embodiments of the present application, the PDCCH skipping may be indicated when a SSSG switching timer is running, then the UE may need to determine when to perform SSSG switching because the PDCCH skipping may end before the expiration of the SSSG switching timer or end after the expiration of the SSSG switching timer.

In such embodiments, the PDCCH skipping may be indicated by DCI transmitted by the BS. That is, the DCI is received when a SSSG switching timer is running. The DCI may indicate a number of PDCCH monitoring occasions or a time period. For example, the DCI may be the DCI in the embodiments of FIG. 7, the DCI in the embodiments in FIG. 4, or any other DCI. Then, after receiving the DCI, the UE may determine a number of skipped PDCCH monitoring occasions or the skipped time period for the current SSSG.

In some embodiments of the present application, the DCI is received when a SSSG switching timer is running and the PDCCH skipping may end before the expiration of the SSSG switching timer. Then, in response to the end of the PDCCH skipping, the UE may perform SSSG switching and terminate the SSSG switching timer. That is, in such embodiments, the SSSG switching timer is early terminated upon the end of PDCCH skipping.

FIG. 10 illustrates an exemplary operation in a scenario where PDCCH skipping is indicated when a SSSG switching timer is running according to some embodiments of the present application.

Referring to FIG. 10, the BS may configure two SSSGs to the UE, i.e., SSSG #0 and SSSG #1. At slot t, the UE may switch from the SSSG #0 to SSSG #1 and starts a SSSG switching timer.

The UE may receive DCI in slot k indicating a PDCCH skipping for a time period. The PDCCP skipping may end before the expiration of the SSSG switching timer. Then, in the embodiment of FIG. 10, at the end of the PDCCH skipping, the UE early terminates the SSSG switching timer and switch from the SSSG #1 to SSSG #0.

In some other embodiments of the present application, the DCI is received when a SSSG switching timer is running and the PDCCH skipping may end after the expiration of the SSSG switching timer.

Then, in an embodiment of the present application, in response to the expiration of the SSSG switching timer, the UE may terminate the PDCCH skipping and perform a SSSG switching. That is, in such embodiment, the PDCCH skipping for the current active SSSG has not been performed completely but is early terminated upon the expiration of the SSSG switching timer.

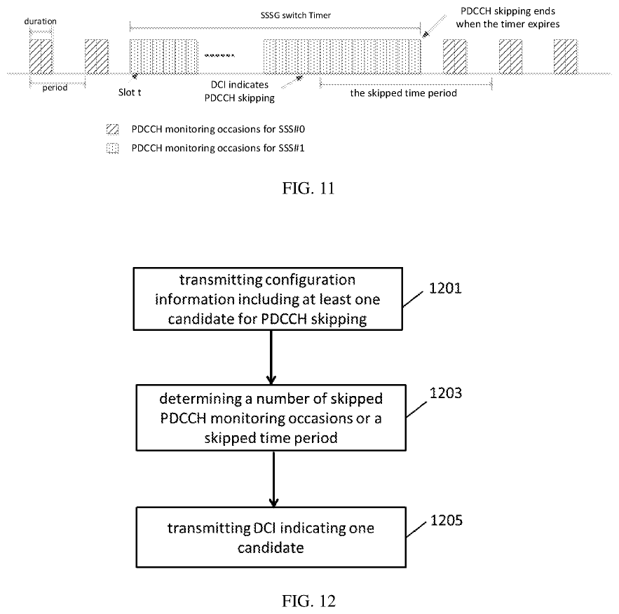

FIG. 11 illustrates another exemplary operation in a scenario where PDCCH skipping is indicated when a SSSG switching timer is running according to some other embodiments of the present application.

Referring to FIG. 11, the BS may configure two SSSGs to the UE, i.e., SSSG #0 and SSSG #1. At slot t, the UE may switch from the SSSG #0 to SSSG #1 and starts a SSSG switching timer.

The UE may receive DCI in slot k indicating a PDCCH skipping for a time period. The PDCCP skipping may end after the expiration of the SSSG switching timer. Then, in the embodiment of FIG. 11, when the SSSG switching timer expires, the UE may terminate the PDCCH skipping and switch from the SSSG #1 to SSSG #0.

In another embodiment of the present application, in the case that the DCI is received when a SSSG switching timer is running and the PDCCH skipping ends after an expiration of the SSSG switching timer, the UE may perform the PDCCH skipping as indicated in the DCI. That is, the PDCCH skipping may end as indicated in the DCI, and the UE may perform the SSSG switching after the end of the PDCCH skipping, instead of performing SSSG switching after expiration of the SSSG switching timer.

According to some embodiments of the present application, the PDCCH skipping and/or a SSSG switching is not allowed when the SSSG switching timer is running.

In such embodiments, when the SSSG switching timer is running, the UE may receive DCI indicating a PDCCH skipping and/or a SSSG switching. For example, the DCI may be the DCI in the embodiments of FIG. 7, the DCI in the embodiments in FIG. 4, or any other DCI.

In some embodiments of the present application, the bit field in the DCI for PDCCH skipping and/or SSSG switching is valid only when the SSG switching timer is not running. In an embodiment of the present application, after receiving the DCI, the UE may determine that a bit filed (e.g., the 2-bit field in FIG. 4) in the DCI for PDCCH skipping and/or SSSG switching in the DCI is invalid when the SSSG switching timer is running. In another embodiment of the present application, the bit field in the DCI for PDCCH skipping and/or SSSG switching may be reserved when the SSSG switching timer is running.

In some other embodiments of the present application, the codepoint for the SSSG switching is valid only when the SSSG switching timer is not running. In an embodiment of the present application, after receiving the DCI, the UE may determine that the codepoint for SSSG switching (e.g., codepoint “11” in FIG. 4) indicated in the DCI is invalid when the SSSG switching timer is running. In another embodiment of the present application, after receiving the DCI, the UE may determine that the codepoint for SSSG switching (e.g., codepoint “11” in FIG. 4) is used for other purpose, e.g., indicating one more candidates of PDCCH skipping when the SSSG switching timer is running.

FIG. 12 is a flow chart illustrating an exemplary procedure of a method for power saving according to some other embodiments of the present application. The method may be performed by a BS, for example, the BS 101 as shown in FIG. 1.

In the exemplary method shown in FIG. 12, in step 1201, the BS may transmit configuration information to a UE (e.g., the BS 101 as shown in FIG. 1). In some embodiments, the configuration information may include at least one candidate for PDCCH skipping. Each candidate indicates a number of PDCCH monitoring occasions or a time period.

In step 1203, the BS may select one candidate from the at least one candidate, and determine a number of skipped PDCCH monitoring occasions or a skipped time period for each SSS based on the one candidate. In an embodiment of the present application, each SSS is included in the current active SSSG. In another embodiment of the present application, the BS does not configure any SSSG to the UE. In other words, all SSSs are not included in any SSSG. In such embodiments, the BS may determine a number of skipped PDCCH monitoring occasions or a skipped time period for each SSS of all the SSSs.

The BS may use the same methods as those used by the UE as described above to determine a number of skipped PDCCH monitoring occasions or a skipped time period for each SSS based on the one candidate.

For example, in some embodiments of the present application, the at least one candidate may be configured for all the SSSGs of the UE. In such embodiments, each candidate may include a number of PDCCH monitoring occasions.

Then, after selecting the one candidate, the BS may determine that the number of PDCCH monitoring occasions indicated by the one candidate is used for the current active SSSG of the UE.

In some other embodiments of the present application, the at least one candidate may be configured for all the SSSs. In such embodiments, each candidate may include a number of PDCCH monitoring occasions.

In an embodiment of the present application, for each SSS included in the current active SSSG or for each SSS of all the SSSs, the BS may determine the number of skipped PDCCH monitoring occasions to be the number of PDCCH monitoring occasions indicated in the one candidate.

In another embodiment of the present application, the number of PDCCH monitoring occasions indicated in the one candidate may be applied for a reference SSS. In an embodiment of the present application, the reference SSS is included in the current active SSSG. In another embodiment of the present application, the reference is included in all the SSSs of the UE. Then, for the reference SSS, the BS may determine the number of skipped PDCCH monitoring occasions to be the number of PDCCH monitoring occasions indicated in the one candidate.

Then, the BS may determine a reference skipped time period (e.g., in terms of time slots) based on the number of PDCCH monitoring occasions indicated in the one candidate. For each SSS other than the reference SSS included in the current active SSSG or included in all the SSSs (in the case that no SSSG is configured for the UE), the BS may determine the number of skipped PDCCH monitoring occasions to be PDCCH monitoring occasions in the reference skipped time period.

In some embodiments of the present application, the reference SSS may be configured by a network. In some other embodiments of the present application, the reference SSS may be determined implicitly, for example, the reference SSS may be a USS with a lowest periodicity (in other words, most densest USS) in the current active SSSG or in all the SSSs (in the case that no SSSG is configured for the UE). In another example, the reference SSS may be a USS with a lowest or a highest index in the current active SSSG or in all the SSSs (in the case that no SSSG is configured for the UE). In yet another example, a default SSS might be defined in the current active SSSG or in all the SSSs (in the case that no SSSG is configured for the UE), and the reference SSS is the default SSS.

In some other embodiments of the present application, the at least one candidate may be configured for a reference SSSG of all the SSSGs configured by the BS. In such embodiments, each candidate may include a time period.

In some embodiments of the present application, the reference SSSG may be configured by the network (e.g., BS). In some other embodiments of the present application, the reference SSSG may be determined implicitly, for example, the reference SSSG may be a densest SSSG in all the SSSGs. In another example, the reference SSSG may be a SSSG with lowest or highest index in all the SSSGs. In yet another example, a default SSSG might be defined in all the SSSGs, and the reference SSSG is the default SSSG.

In such embodiments, in the case that the current SSSG is the reference SSSG, the BS may determine the time period can be directly used as the skipped time period for the current SSSG. Then, the BS may determine the skipped time period for each SSS included in the current active SSSG to be the time period indicated in the one candidate.

In the case that the current SSSG is not the reference SSSG, the BS may determine the time period cannot be directly used as the skipped time period for the current SSSG, and the skipped time period for the current SSSG may be determined based on the time period indicated in the one candidate and a scaling factor. That is, the BS may determine the skipped time period for each SSS included in the current active SSSG based on the time period indicated in the one candidate and a scaling factor. For example, the skipped time period may be determined to be the time period indicated in the one candidate multiplying the scaling factor.

In some embodiments of the present application, the scaling factor may be configured by the network (e.g., BS). In some other embodiments of the present application, the scaling factor may be determined based on a first number of PDCCH monitoring occasions (e.g., N1) within a determined time period of a first reference SSS of the reference SSSG and a second number of PDCCH monitoring occasions (N2) within the determined time period of a second reference SSS in the current active SSSG, for example, the scaling factor may be determined to be N1/N2.

In some embodiments, the determined time period may be configured by the network (e.g., BS). In some other embodiments of the present application, the time period is the period of reference SSS (e.g., the first reference SSS) of the reference SSSG.

The first reference SSS may be configured by a network or may be determined implicitly, for example, the first reference SSS may be a USS with a lowest periodicity (in other words, densest USS) in the reference SSSG In another example, the first reference SSS may be a USS with a lowest or a highest index in the reference SSSG. In yet another example, a default SSS might be defined in the reference SSSG, and the first reference SSS is the default SSS.

Similarly, the second reference SSS may be configured by a network or may be determined implicitly, for example, the second reference SSS may be a USS with a lowest periodicity (in other words, densest USS) in the current active SSSG. In another example, the second reference SSS may be a USS with lowest or highest index in the current active SSSG. In yet another example, a default SSS might be defined in the current active SSSG, and the second reference SSS is the default SSS.

After determining the number of skipped PDCCH monitoring occasions or the skipped time period for each SSS included in the current active SSSG based on the one candidate, in step 1205, the BS may transmit DCI indicating the one candidate to the UE.

According to some embodiments of the present application, the current active SSSG may to a denser SSSG. When a PDCCH skipping is indicated by the BS, the SSSG can be changed to a sparser SSSG after ends of the PDCCH skipping.

In such embodiments, the BS may transmit DCI indicting a PDCCH skipping. The DCI may indicate a number of PDCCH monitoring occasions or a time period. For example, the DCI may be the DCI in the embodiments of FIG. 7, the DCI in the embodiments in FIG. 4, or any other DCI. The BS may determine a number of skipped PDCCH monitoring occasions or a skipped time period for the current active SSSG.

After performing the PDCCH skipping for the current active SSSG, the BS may determine whether to switch to an SSSG sparser than the current active SSSG in response to whether the number of skipped PDCCH monitoring occasions or the skipped time period is larger than or equal to a threshold. For example, in the case that the number of skipped PDCCH monitoring occasions or the skipped time period is larger than or equal to a threshold, the BS may determine to switch to an SSSG sparser than the current active SSSG.

In some embodiments of the present application, the threshold may be configured by the network (e.g., BS). In some other embodiments of the present application, the threshold may be determined based on (e.g., equal to) a PDCCH monitoring periodicity configured for a reference SSS of the SSSG sparser than the current active SSSG. In such embodiments, the reference SSS may be configured by a network or may be determined implicitly, for example, the reference SSS may be a USS with a lowest periodicity (in other words, densest USS) in the SSSG. In another example, the reference SSS may be a USS with a lowest or a highest index in the SSSG. In yet another example, a default SSS might be defined in the SSSG, and the reference SSS is the default SSS.

According to some embodiments of the present application, the BS may transmit DCI indicating a PDCCH skipping when a SSSG switching timer is running, then the BS may need to determine when to perform SSSG switching because the PDCCH skipping may end before the expiration of the SSSG switching timer or end after the expiration of the SSSG switching timer.

In such embodiments, the DCI may indicate a number of PDCCH monitoring occasions or a time period. For example, the DCI may be the DCI in the embodiments of FIG. 7, the DCI in the embodiments in FIG. 4, or any other DCI. The BS may determine a number of skipped PDCCH monitoring occasions or the skipped time period for the current SSSG.

In some embodiments of the present application, the DCI is transmitted when a SSSG switching timer is running and the PDCCH skipping may end before the expiration of the SSSG switching timer. Then, in response to the end of the PDCCH skipping, the BS may perform SSSG switching and terminate the SSSG switching timer. That is, in such embodiments, the SSSG switching timer is early terminated upon the end of PDCCH skipping.

In some other embodiments of the present application, the DCI is transmitted when a SSSG switching timer is running and the PDCCH skipping may end after the expiration of the SSSG switching timer.

Then, in an embodiment of the present application, in response to the expiration of the SSSG switching timer, the BS may terminate the PDCCH skipping and perform a SSSG switching. That is, in such embodiment, the PDCCH skipping for the current active SSSG has not been performed completely but is early terminated upon the expiration of the SSSG switching timer.

In another embodiment of the present application, in the case that the DCI is transmitted when a SSSG switching timer is running and the PDCCH skipping ends after an expiration of the SSSG switching timer, PDCCH skipping may end as indicated in the DCI, and the BS may perform the SSSG switching after the end of the PDCCH skipping, instead of performing SSSG switching after expiration of the SSSG switching timer.

According to some embodiments of the present application, the PDCCH skipping and/or a SSSG switching is not allowed when the SSSG switching timer is running.

In such embodiments, when the SSSG switching timer is running, the BS may transmit DCI indicating a PDCCH skipping and/or a SSSG switching. For example, the DCI may be the DCI in the embodiments of FIG. 7, the DCI in the embodiments in FIG. 4, or any other DCI.

In some embodiments of the present application, the bit field in the DCI for PDCCH skipping and/or SSSG switching is valid only when the SSG switching timer is not running. In an embodiment of the present application, a bit filed (e.g., the 2-bit field in FIG. 4) in the DCI for PDCCH skipping and/or SSSG switching in the DCI is invalid when the SSSG switching timer is running. In another embodiment of the present application, the bit field in the DCI for PDCCH skipping and/or SSSG switching may be reserved when the SSSG switching timer is running.

In some other embodiments of the present application, the codepoint for the SSSG switching indicated in the DCI is valid only when the SSG switching timer is not running. In an embodiment of the present application, the codepoint for SSSG switching (e.g., codepoint “11” in FIG. 4) in valid when the SSG switching timer is running. In another embodiment of the present application, the codepoint for SSSG switching (e.g., codepoint “11” in FIG. 4) is used for other purpose, e.g., indicating one more candidates of PDCCH skipping when the SSG switching timer is running.

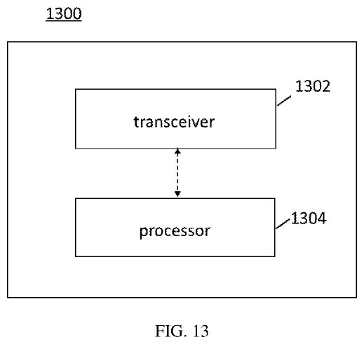

FIG. 13 illustrates a simplified block diagram of an exemplary apparatus for power saving according to some embodiments of the present application. The apparatus 1300 may include a UE (e.g., UE 102) or a BS (e.g., a BS 101).

Referring to FIG. 13, the apparatus 1300 may include at least one processor 1304 and at least one transceiver 1302 coupled to the processor 1304.

Although in this figure, elements such as the at least one transceiver 1302 and processor 1304 are described in the singular, the plural is contemplated unless a limitation to the singular is explicitly stated. In some embodiments of the present application, the transceiver 1302 may be divided into two devices, such as a receiving circuitry and a transmitting circuitry. In some embodiments of the present application, the apparatus 1300 may further include an input device, a memory, and/or other components.

According to some embodiments of the present application, the apparatus 1300 may be a UE. The transceiver 1302 of the UE may be configured to receive configuration information including at least one candidate for PDCCH skipping, wherein each candidate indicates a number of PDCCH monitoring occasions or a time period; and receive DCI indicating one candidate of the at least one candidate for a SSSG. The processor 1304 may be configured to determine a number of skipped PDCCH monitoring occasions or a skipped time period for each SSS included in the current active SSSG based on the one candidate.

In some embodiments of the present application, the processor 1304 is further configured to: for each SSS included in the current active SSSG, determine the number of skipped PDCCH monitoring occasions to be the number of PDCCH monitoring occasions indicated in the one candidate.

In some embodiments of the present application, the processor 1304 is further configured to: for a reference SSS included in the current active SSSG, determine the number of skipped PDCCH monitoring occasions to be the number of PDCCH monitoring occasions indicated in the one candidate.

In an embodiment of the present application, the processor 1304 is further configured to: determine a reference skipped time period based on the number of PDCCH monitoring occasions indicated in the one candidate; and for each SSS other than the reference SSS included in the current active SSSG, determine the number of skipped PDCCH monitoring occasions to be PDCCH monitoring occasions in the reference skipped time period.

In another embodiment of the present application, the reference SSS is configured by a network or is a USS with a lowest periodicity in the current active SSSG. In another example, the reference SSS may be a USS with a lowest or a highest index in the current active SSSG. In yet another example, a default SSS might be defined in the current active SSSG, and the reference SSS is the default SSS.

In some embodiments of the present application, the at least one candidate indicating the time period is configured for a reference SSSG.

In an embodiment of the present application, the processor 1304 is further configured to: in the case that the current active SSSG is the reference SSSG, determine the skipped time period for each SSS included in the current active SSSG to be the time period indicated in the one candidate; and in the case that the current active SSSG is not the reference SSSG, determine the skipped time period for each SSS included in the current active SSSG based on the time period indicated in the one candidate and a scaling factor, wherein the scaling factor is configured by a network or determined based on a first number of PDCCH monitoring occasions within a determined time period of a first reference SSS of the reference SSSG and a second number of PDCCH monitoring occasions within the determined time period of a second reference SSS in the current active SSSG.

In some embodiments of the present application, the processor 1304 is further configured to: determine to switch to an SSSG sparser than the current active SSSG in response to the number of skipped PDCCH monitoring occasions or the skipped time period is larger than or equal to a threshold, wherein the threshold is configured by a network or determined based on a PDCCH monitoring periodicity configured for a reference SSS of the SSSG.

In some embodiments of the present application, in the case that the DCI is received when a SSSG switching timer is running and the PDCCH skipping ends before an expiration of the SSSG switching timer, the processor 1304 is further configured to: perform a SSSG switching and terminate the SSSG switching timer in response to an end of the PDCCH skipping.

In some embodiments of the present application, in the case that the DCI is received when a SSSG switching timer is running and the PDCCH skipping ends after an expiration of the SSSG switching timer, the processor 1304 is further configured to: terminate the PDCCH skipping and perform a SSSG switching in response to the expiration of the SSSG switching timer; or perform an SSSG switching in response to an end of PDCCH skipping.

In some embodiments of the present application, in the case that the DCI is received when a SSSG switching timer is running, a bit filed for PDCCH skipping and/or SSSG switching in the DCI is invalid.

In some embodiments of the present application, in the case that the DCI is received when a SSSG switching timer is running, a codepoint of a bit field in the DCI for SSSG switching is invalid or used for indicating one or more candidates for PDCCH skipping.

According to some embodiments of the present application, the apparatus 1300 may be a BS. The transceiver 1302 of the BS may be configured to transmit configuration information including at least one candidate for PDCCH skipping, wherein each candidate indicates a number of PDCCH monitoring occasions or a time period; and transmit DCI indicating one candidate of the at least one candidate for a SSSG. The processor 1304 may be configured to determine a number of skipped PDCCH monitoring occasions or a skipped time period for each SSS included in the current active SSSG based on the one candidate.

In some embodiments of the present application, the processor 1304 is further configured to: for each SSS included in the current active SSSG, determine the number of skipped PDCCH monitoring occasions to be the number of PDCCH monitoring occasions indicated in the one candidate.

In some embodiments of the present application, the processor 1304 is further configured to: for a reference SSS included in the current active SSSG, determine the number of skipped PDCCH monitoring occasions to be the number of PDCCH monitoring occasions indicated in the one candidate.

In an embodiment of the present application, the processor 1304 is further configured to: determine a reference skipped time period based on the number of PDCCH monitoring occasions indicated in the one candidate; and for each SSS other than the reference SSS included in the current active SSSG, determine the number of skipped PDCCH monitoring occasions to be PDCCH monitoring occasions in the reference skipped time period.

In another embodiment of the present application, the reference SSS is configured by a network or is a USS with a lowest periodicity in the current active SSSG.

In some embodiments of the present application, the at least one candidate indicating the time period is configured for a reference SSSG.

In an embodiment of the present application, the processor 1304 is further configured to: in the case that the current active SSSG is the reference SSSG, determine the skipped time period for each SSS included in the current active SSSG to be the time period indicated in the one candidate; and in the case that the current active SSSG is not the reference SSSG, determine the skipped time period for each SSS included in the current active SSSG based on the time period indicated in the one candidate and a scaling factor, wherein the scaling factor is configured by a network or determined based on a first number of PDCCH monitoring occasions within a determined time period of a first reference SSS of the reference SSSG and a second number of PDCCH monitoring occasions within the determined time period of a second reference SSS in the current active SSSG.

In some embodiments of the present application, the processor 1304 is further configured to: determine to switch to an SSSG sparser than the current active SSSG in response to the number of skipped PDCCH monitoring occasions or the skipped time period is larger than or equal to a threshold, wherein the threshold is configured by a network or determined based on a PDCCH monitoring periodicity configured for a reference SSS of the SSSG.

In some embodiments of the present application, in the case that the DCI is transmitted when a SSSG switching timer is running and the PDCCH skipping ends before an expiration of the SSSG switching timer, the processor is further configured to: perform a SSSG switching and terminate the SSSG switching timer in response to an end of the PDCCH skipping.

In some embodiments of the present application, in the case that the DCI is transmitted when a SSSG switching timer is running and the PDCCH skipping ends after an expiration of the SSSG switching timer, the processor is further configured to:

terminate the PDCCH skipping and perform a SSSG switching in response to the expiration of the SSSG switching timer; or perform an SSSG switching in response to an end of PDCCH skipping.

In some embodiments of the present application, in the case that the DCI is received when a SSSG switching timer is running, a bit filed for PDCCH skipping and/or SSSG switching in the DCI is invalid.

In some embodiments of the present application, in the case that the DCI is received when a SSSG switching timer is running, a codepoint of a bit field in the DCI for SSSG switching is invalid or used for indicating one or more candidates for PDCCH skipping.

In some embodiments of the present application, the apparatus 1300 may further include at least one non-transitory computer-readable medium. In some embodiments of the present application, the non-transitory computer-readable medium may have stored thereon computer-executable instructions to cause a processor to implement the method with respect to a UE or a BS as described above. For example, the computer-executable instructions, when executed, cause the processor 1304 to interact with the transmitter and/or the receiver, so as to perform operations of the methods, e.g., as described in view of any of FIGS. 7 and 12.

Some embodiments of the present application may be disclosed below:

Embodiment 1: A UE, comprising:
a processor; and
a transceiver coupled to the processor,
wherein the transceiver is configured to:
   receive configuration information including at least one candidate for PDCCH skipping, wherein each candidate indicates a number of PDCCH monitoring occasions or a time period; and
   receive DCI indicating one candidate of the at least one candidate for a current active SSSG;
wherein the processor is configured to:
   determine a number of skipped PDCCH monitoring occasions or a skipped time period for each SSS included in the current active SSSG based on the one candidate.
      Embodiment 2: The UE of Embodiment 1, the processor is further configured to: for each SSS included in the current active SSSG, determine the number of skipped PDCCH monitoring occasions to be the number of PDCCH monitoring occasions indicated in the one candidate.
      Embodiment 3: The UE of Embodiment 1, the processor is further configured to: for a reference SSS included in the current active SSSG, determine the number of skipped PDCCH monitoring occasions to be the number of PDCCH monitoring occasions indicated in the one candidate.
      Embodiment 4: The UE of Embodiment 3, the processor is further configured to:
determine a reference skipped time period based on the number of PDCCH monitoring occasions indicated in the one candidate; and
for each SSS other than the reference SSS included in the current active SSSG, determine the number of skipped PDCCH monitoring occasions to be PDCCH monitoring occasions in the reference skipped time period.
   Embodiment 5: The UE of Embodiment 3, the reference SSS is configured by a network or is a USS with a lowest periodicity in the current active SSSG.
   Embodiment 6: The UE of Embodiment 1, the at least one candidate indicating the time period is configured for a reference SSSG.
   Embodiment 7: The UE of Embodiment 1, wherein the processor is further configured to:
in the case that the current active SSSG is the reference SSSG, determine the skipped time period for each SSS included in the current active SSSG to be the time period indicated in the one candidate; and
in the case that the current active SSSG is not the reference SSSG, determine the skipped time period for each SSS included in the current active SSSG based on the time period indicated in the one candidate and a scaling factor,
wherein the scaling factor is configured by a network or determined based on a first number of PDCCH monitoring occasions within a determined time period of a first reference SSS of the reference SSSG and a second number of PDCCH monitoring occasions within the determined time period of a second reference SSS in the current active SSSG.
   Embodiment 8: The UE of Embodiment 1, the processor is further configured to: determine to switch to an SSSG sparser than the current active SSSG in response to the number of skipped PDCCH monitoring occasions or the skipped time period is larger than or equal to a threshold, wherein the threshold is configured by a network or determined based on a PDCCH monitoring periodicity configured for a reference SSS of the SSSG.
   Embodiment 9: The UE of Embodiment 1, in the case that the DCI is received when a SSSG switching timer is running and the PDCCH skipping ends before an expiration of the SSSG switching timer, the processor is further configured to: perform a SSSG switching and terminate the SSSG switching timer in response to an end of the PDCCH skipping.
   Embodiment 10: The UE of Embodiment 1, in the case that the DCI is received when a SSSG switching timer is running and the PDCCH skipping ends after an expiration of the SSSG switching timer, the processor is further configured to: terminate the PDCCH skipping and perform a SSSG switching in response to the expiration of the SSSG switching timer; or perform an SSSG switching in response to an end of PDCCH skipping.
   Embodiment 11: The UE of Embodiment 1, in the case that the DCI is received when a SSSG switching timer is running, a bit filed for PDCCH skipping and/or SSSG switching in the DCI is invalid.
   Embodiment 12: The UE of Embodiment 1, in the case that the DCI is received when a SSSG switching timer is running, a codepoint of a bit field in the DCI for SSSG switching is invalid or used for indicating one or more candidates for PDCCH skipping.
   Embodiment 13: A BS, comprising:
a processor; and
a transceiver coupled to the processor,
wherein the transceiver is configured to:
   transmit configuration information including at least one candidate for PDCCH skipping, wherein each candidate indicates a number of PDCCH monitoring occasions or a time period; and
   transmit DCI indicating one candidate of the at least one candidate for a current active SSSG;
wherein the processor is configured to:
   determine a number of skipped PDCCH monitoring occasions or a skipped time period for each SSS included in the current active SSSG based on the one candidate.
      Embodiment 14: The BS of Embodiment 13, the processor is further configured to: for each SSS included in the current active SSSG, determine the number of skipped PDCCH monitoring occasions to be the number of PDCCH monitoring occasions indicated in the one candidate.
      Embodiment 15: The BS of Embodiment 13, the processor is further configured to: for a reference SSS included in the current active SSSG, determine the number of skipped PDCCH monitoring occasions to be the number of PDCCH monitoring occasions indicated in the one candidate.
      Embodiment 16: The BS of Embodiment 15, the processor is further configured to:
determine a reference skipped time period based on the number of PDCCH monitoring occasions indicated in the one candidate; and
for each SSS other than the reference SSS included in the current active SSSG, determine the number of skipped PDCCH monitoring occasions to be PDCCH monitoring occasions in the reference skipped time period.
   Embodiment 17: The BS of Embodiment 15, the reference SSS is configured by a network or is a USS with a lowest periodicity in the current active SSSG.
   Embodiment 18: The BS of Embodiment 13, the at least one candidate indicating the time period is configured for a reference SSSG.
   Embodiment 19: The BS of Embodiment 13, wherein the processor is further configured to:
in the case that the current active SSSG is the reference SSSG, determine the skipped time period for each SSS included in the current active SSSG to be the time period indicated in the one candidate; and
in the case that the current active SSSG is not the reference SSSG, determine the skipped time period for each SSS included in the current active SSSG based on the time period indicated in the one candidate and a scaling factor,
wherein the scaling factor is configured by a network or determined based on a first number of PDCCH monitoring occasions within a determined time period of a first reference SSS of the reference SSSG and a second number of PDCCH monitoring occasions within the determined time period of a second reference SSS in the current active SSSG.
   Embodiment 20: The BS of Embodiment 13, the processor is further configured to: determine to switch to an SSSG sparser than the current active SSSG in response to the number of skipped PDCCH monitoring occasions or the skipped time period is larger than or equal to a threshold, wherein the threshold is configured by a network or determined based on a PDCCH monitoring periodicity configured for a reference SSS of the SSSG.
   Embodiment 21: The BS of Embodiment 13, in the case that the DCI is transmitted when a SSSG switching timer is running and the PDCCH skipping ends before an expiration of the SSSG switching timer, the processor is further configured to: perform a SSSG switching and terminate the SSSG switching timer in response to an end of the PDCCH skipping.
   Embodiment 22: The BS of Embodiment 13, in the case that the DCI is transmitted when a SSSG switching timer is running and the PDCCH skipping ends after an expiration of the SSSG switching timer, the processor is further configured to: terminate the PDCCH skipping and perform a SSSG switching in response to the expiration of the SSSG switching timer; or perform an SSSG switching in response to an end of PDCCH skipping.
   Embodiment 23: The BS of Embodiment 13, in the case that the DCI is transmitted when a SSSG switching timer is running, a bit filed for PDCCH skipping and/or SSSG switching in the DCI is invalid.
   Embodiment 24: The BS of Embodiment 13, in the case that the DCI is transmitted when a SSSG switching timer is running, a codepoint of a bit field in the DCI for SSSG switching is invalid or used for indicating one or more candidates for PDCCH skipping.
   Embodiment 25: A method performed by a UE, comprising:
receiving configuration information including at least one candidate for PDCCH skipping, wherein each candidate indicates a number of PDCCH monitoring occasions or a time period; and
receiving DCI indicating one candidate of the at least one candidate for a current active SSSG;
wherein the processor is configured to:
determining a number of skipped PDCCH monitoring occasions or a skipped time period for each SSS included in the current active SSSG based on the one candidate.
   Embodiment 26: The method of Embodiment 25, further comprising: for each SSS included in the current active SSSG, determining the number of skipped PDCCH monitoring occasions to be the number of PDCCH monitoring occasions indicated in the one candidate.
   Embodiment 27: The method of Embodiment 25, further comprising: for a reference SSS included in the current active SSSG, determining the number of skipped PDCCH monitoring occasions to be the number of PDCCH monitoring occasions indicated in the one candidate.
   Embodiment 28: The method of Embodiment 27, further comprising:
determining a reference skipped time period based on the number of PDCCH monitoring occasions indicated in the one candidate; and
for each SSS other than the reference SSS included in the current active SSSG, determining the number of skipped PDCCH monitoring occasions to be PDCCH monitoring occasions in the reference skipped time period.
   Embodiment 29: The method of Embodiment 27, the reference SSS is configured by a network or is a USS with a lowest periodicity in the current active SSSG.
   Embodiment 30: The method of Embodiment 25, the at least one candidate indicating the time period is configured for a reference SSSG.
   Embodiment 31: The method of Embodiment 25, further comprising:
in the case that the current active SSSG is the reference SSSG, determining the skipped time period for each SSS included in the current active SSSG to be the time period indicated in the one candidate; and
in the case that the current active SSSG is not the reference SSSG, determining the skipped time period for each SSS included in the current active SSSG based on the time period indicated in the one candidate and a scaling factor,
wherein the scaling factor is configured by a network or determined based on a first number of PDCCH monitoring occasions within a determined time period of a first reference SSS of the reference SSSG and a second number of PDCCH monitoring occasions within the determined time period of a second reference SSS in the current active SSSG.
   Embodiment 32: The method of Embodiment 25, further comprising:

determining to switch to an SSSG sparser than the current active SSSG in response to the number of skipped PDCCH monitoring occasions or the skipped time period is larger than or equal to a threshold, wherein the threshold is configured by a network or determined based on a PDCCH monitoring periodicity configured for a reference SSS of the SSSG.

Embodiment 33: The method of Embodiment 25, in the case that the DCI is received when a SSSG switching timer is running and the PDCCH skipping ends before an expiration of the SSSG switching timer, the method further comprises: performing a SSSG switching and terminating the SSSG switching timer in response to an end of the PDCCH skipping.
Embodiment 34: The method of Embodiment 25, in the case that the DCI is received when a SSSG switching timer is running and the PDCCH skipping ends after an expiration of the SSSG switching timer, the method further comprises: terminating the PDCCH skipping and perform a SSSG switching in response to the expiration of the SSSG switching timer; or performing an SSSG switching in response to an end of PDCCH skipping.
Embodiment 35: The method of Embodiment 25, in the case that the DCI is received when a SSSG switching timer is running, a bit filed for PDCCH skipping and/or SSSG switching in the DCI is invalid.
Embodiment 36: The method of Embodiment 25, in the case that the DCI is received when a SSSG switching timer is running, a codepoint of a bit field in the DCI for SSSG switching is invalid or used for indicating one or more candidates for PDCCH skipping.
Embodiment 37: A method performed by a BS, comprising:
transmitting configuration information including at least one candidate for PDCCH skipping, wherein each candidate indicates a number of PDCCH monitoring occasions or a time period;
determining a number of skipped PDCCH monitoring occasions or a skipped time period for each SSS included in a current SSSG based on one candidate of the at least one candidate; and
transmitting DCI indicating the one candidate of the at least one candidate.
   Embodiment 38: The method of Embodiment 37, further comprising: for each SSS included in the current active SSSG, determine the number of skipped PDCCH monitoring occasions to be the number of PDCCH monitoring occasions indicated in the one candidate.
   Embodiment 39: The method of Embodiment 37, further comprising: for a reference SSS included in the current active SSSG, determine the number of skipped PDCCH monitoring occasions to be the number of PDCCH monitoring occasions indicated in the one candidate.
   Embodiment 40: The method of Embodiment 39, further comprising:
determining a reference skipped time period based on the number of PDCCH monitoring occasions indicated in the one candidate; and
for each SSS other than the reference SSS included in the current active SSSG,
determining the number of skipped PDCCH monitoring occasions to be PDCCH
monitoring occasions in the reference skipped time period.
   Embodiment 41: The method of Embodiment 37, the reference SSS is configured by a network or is a USS with a lowest periodicity in the current active SSSG.
   Embodiment 42: The method of Embodiment 37, the at least one candidate indicating the time period is configured for a reference SSSG.
   Embodiment 43: The method of Embodiment 42, further comprising:
in the case that the current active SSSG is the reference SSSG, determining the skipped time period for each SSS included in the current active SSSG to be the time period indicated in the one candidate; and
in the case that the current active SSSG is not the reference SSSG, determining the skipped time period for each SSS included in the current active SSSG based on the time period indicated in the one candidate and a scaling factor,
wherein the scaling factor is configured by a network or determined based on a first number of PDCCH monitoring occasions within a determined time period of a first reference SSS of the reference SSSG and a second number of PDCCH monitoring occasions within the determined time period of a second reference SSS in the current active SSSG.
   Embodiment 44: The method of Embodiment 37, further comprising:

determining to switch to an SSSG sparser than the current active SSSG in response to the number of skipped PDCCH monitoring occasions or the skipped time period is larger than or equal to a threshold, wherein the threshold is configured by a network or determined based on a PDCCH monitoring periodicity configured for a reference SSS of the SSSG.

Embodiment 45: The method of Embodiment 37, in the case that the DCI is transmitted when a SSSG switching timer is running and the PDCCH skipping ends before an expiration of the SSSG switching timer, the method further comprises: performing a SSSG switching and terminate the SSSG switching timer in response to an end of the PDCCH skipping.
Embodiment 46: The method of Embodiment 37, in the case that the DCI is transmitted when a SSSG switching timer is running and the PDCCH skipping ends after an expiration of the SSSG switching timer, the method further comprises: terminating the PDCCH skipping and perform a SSSG switching in response to the expiration of the SSSG switching timer; or performing an SSSG switching in response to an end of PDCCH skipping.
Embodiment 47: The method of Embodiment 37, in the case that the DCI is transmitted when a SSSG switching timer is running, a bit filed for PDCCH skipping and/or SSSG switching in the DCI is invalid.
Embodiment 48: The method of Embodiment 37, in the case that the DCI is transmitted when a SSSG switching timer is running, a codepoint of a bit field in the DCI for SSSG switching is invalid or used for indicating one or more candidates for PDCCH skipping.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for power saving, including a processor and a memory. Computer programmable instructions for implementing a method for power saving are stored in the memory, and the processor is configured to perform the computer programmable instructions to implement the method for power saving. The method for power saving may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for power saving according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE), comprising:
at least one memory; and
at least one processor coupled with the at least one memory and configured to cause the UE to:
receive configuration information including at least one candidate for physical downlink control channel (PDCCH) skipping, wherein each candidate indicates a number of PDCCH monitoring occasions or a time period;
receive downlink control information (DCI) indicating one candidate of the at least one candidate for a current active search space set (SSS) group (SSSG);
determine a number of skipped PDCCH monitoring occasions or a skipped time period for each SSS included in the current active SSSG based on the one candidate.

2. The UE of claim 1, wherein the at least one processor is further configured to cause the UE to:
for each SSS included in the current active SSSG, determine the number of skipped PDCCH monitoring occasions to be the number of PDCCH monitoring occasions indicated in the one candidate.

3. The UE of claim 1, wherein the at least one processor is further configured to cause the UE to:
for a reference SSS included in the current active SSSG, determine the number of skipped PDCCH monitoring occasions to be the number of PDCCH monitoring occasions indicated in the one candidate.

4. The UE of claim 3, wherein the at least one processor is further configured to cause the UE to:
determine a reference skipped time period based on the number of PDCCH monitoring occasions indicated in the one candidate; and
for each SSS other than the reference SSS included in the current active SSSG, determine the number of skipped PDCCH monitoring occasions to be PDCCH monitoring occasions in the reference skipped time period.

5. The UE of claim 3, wherein the reference SSS is configured by a network or is a UE specific search space set (USS) with a lowest periodicity in the current active SSSG.

6. The UE of claim 1, wherein the at least one candidate indicating the time period is configured for a reference SSSG.

7. The UE of claim 6, wherein the at least one processor is further configured to cause the UE to:
when the current active SSSG is the reference SSSG, determine the skipped time period for each SSS included in the current active SSSG to be the time period indicated in the one candidate; and
when the current active SSSG is not the reference SSSG, determine the skipped time period for each SSS included in the current active SSSG based on the time period indicated in the one candidate and a scaling factor,
wherein the scaling factor is configured by a network or determined based on a first number of PDCCH monitoring occasions within a determined time period of a first reference SSS of the reference SSSG and a second number of PDCCH monitoring occasions within the determined time period of a second reference SSS in the current active SSSG.

8. The UE of claim 1, wherein the at least one processor is further configured to cause the UE to:
switch to an SSSG sparser instead of the current active SSSG when the number of skipped PDCCH monitoring occasions or the skipped time period is larger than or equal to a threshold, wherein the threshold is configured by a network or determined based on a PDCCH monitoring periodicity configured for a reference SSS of the SSSG.

9. The UE of claim 1, wherein, when the DCI is received when a SSSG switching timer is running and the PDCCH skipping ends before an expiration of the SSSG switching timer, the at least one processor is further configured to cause the UE to:
perform a SSSG switching and terminate the SSSG switching timer in response to an end of the PDCCH skipping.

10. The UE of claim 1, wherein, when the DCI is received when a SSSG switching timer is running and the PDCCH skipping ends after an expiration of the SSSG switching timer, the at least one processor is further configured to cause the UE to:
terminate the PDCCH skipping and perform a SSSG switching in response to the expiration of the SSSG switching timer; or
perform an SSSG switching in response to an end of PDCCH skipping.

11. The UE of claim 1, wherein, when the DCI is received when a SSSG switching timer is running, a bit filed for PDCCH skipping or SSSG switching in the DCI is invalid.

12. The UE of claim 1, wherein, when the DCI is received when a SSSG switching timer is running, a codepoint of a bit field in the DCI for SSSG switching is invalid or used for indicating one or more candidates for PDCCH skipping.

13. A base station (BS), comprising:
at least one memory; and
at least one processor coupled with the at least one memory and configured to cause the BS to:
transmit configuration information including at least one candidate for physical downlink control channel (PDCCH) skipping, wherein each candidate indicates a number of PDCCH monitoring occasions or a time period;
transmit downlink control information (DCI) indicating one candidate of the at least one candidate for a current active search space set (SSS) group (SSSG); and
determine a number of skipped PDCCH monitoring occasions or a skipped time period for each SSS included in the current active SSSG based on the one candidate.

14. A method performed by a user equipment (UE), the method comprising:
receiving configuration information including at least one candidate for physical downlink control channel (PDCCH) skipping, wherein each candidate indicates a number of PDCCH monitoring occasions or a time period;
receiving downlink control information (DCI) indicating one candidate of the at least one candidate for a current active search space set (SSS) group (SSSG); and
determining a number of skipped PDCCH monitoring occasions or a skipped time period for each SSS included in the current active SSSG based on the one candidate.

15. (canceled)

16. A processor for wireless communication, comprising:
at least one controller coupled with at least one memory and configured to cause the processor to:
receive configuration information including at least one candidate for physical downlink control channel (PDCCH) skipping, wherein each candidate indicates a number of PDCCH monitoring occasions or a time period;
receive downlink control information (DCI) indicating one candidate of the at least one candidate for a current active search space set (SSS) group (SSSG); and
determine a number of skipped PDCCH monitoring occasions or a skipped time period for each SSS included in the current active SSSG based on the one candidate.

17. The processor of claim 16, wherein the at least one controller is further configured to cause the processor to:
for each SSS included in the current active SSSG, determine the number of skipped PDCCH monitoring occasions to be the number of PDCCH monitoring occasions indicated in the one candidate.

18. The processor of claim 16, wherein the at least one controller is further configured to cause the processor to:
for a reference SSS included in the current active SSSG, determine the number of skipped PDCCH monitoring occasions to be the number of PDCCH monitoring occasions indicated in the one candidate.

19. The processor of claim 18, wherein the at least one controller is further configured to cause the processor to:
determine a reference skipped time period based on the number of PDCCH monitoring occasions indicated in the one candidate; and
for each SSS other than the reference SSS included in the current active SSSG, determine the number of skipped PDCCH monitoring occasions to be PDCCH monitoring occasions in the reference skipped time period.

20. The processor of claim 18, wherein the reference SSS is configured by a network or is a UE specific search space set (USS) with a lowest periodicity in the current active SSSG.

21. The processor of claim 16, wherein the at least one candidate indicating the time period is configured for a reference SSSG.
